(19) United States
(12) Patent Application Publication
(10) Pub. No.: US 2010/0287933 A1
(43) Pub. Date: Nov. 18, 2010

(54) THERMAL ENERGY STORAGE APPARATUS

(76) Inventors: Hassan S. NIKNAFS, Stow, OH (US); Daniel C. Sherman, Hudson, OH (US); Dean Warner, Kent, OH (US); Thomas Szymanski, Hudson, OH (US); Andrew Addie, Stow, OH (US)

Correspondence Address: SAINT-GOBAIN NORPRO, 3840 FISHCREEK ROAD, STOW, OH, 44224, US

(21) Appl. No.: 12/779,995

(22) Filed: May 14, 2010

Related U.S. Application Data
(63) Continuation of application No. 61/179,189, filed on May 18, 2009.

(51) Int. Cl. F03G 6/00; F24J 2/34; F28D 17/00

(52) U.S. Cl. 60/641.8; 126/617; 165/10

(57) ABSTRACT

A thermal energy storage apparatus capable of storing large quantities of heat uses a plurality of energy storage zones having essentially the same thermal energy storage capacity per zone. The flow of a fluid into each zone is separately and independently controlled thereby creating a modular system that is capable of responding to rapid changes in the supply of and/or demand for thermal energy.

### CROSS-REFERENCE TO RELATED APPLICATION

This application claims the benefit of U.S. Provisional Application No. 61/179,189 filed May 18, 2009.

### BACKGROUND OF THE INVENTION

This invention generally relates to the absorption and release of thermal energy. More particularly, this invention is concerned with absorbing and releasing large quantities of heat which can be used by an energy consuming device such as a solar powered electrical generating station.

### SUMMARY

Embodiments of the present invention can be used to absorb large quantities of heat over a first sustained period of time and then release the heat over a second sustained period of time to compensate for differences between the times when the heat is available and when the heat is needed. The ability to quickly and efficiently adjust the thermal energy storage apparatus to significant fluctuations in the availability and/or demand for heat is a technical problem that may impact any process where recovery of the heat is desired.

In one embodiment, the present invention is a thermal energy storage apparatus that includes thermal storage media equally distributed among a plurality of energy storage zones. Each zone is connected to a fluid distribution system. A fluid circulates through the zones and the distribution system. Means for separately and independently controlling the flow of the fluid through each zone is included.

Another embodiment also relates to a process for extracting thermal energy from a fluid. The process may include the following steps. Providing a thermal energy storage apparatus which comprises thermal storage media equally distributed among a plurality of energy storage zones including a first zone and a second zone. Each zone is connected to a fluid distribution system. A fluid circulates through the zones and the distribution system. Means for separately and independently controlling the flow of fluid through each zone is included. Next, causing the fluid to flow through the first zone in a first direction and preventing fluid from flowing through the second zone. The media in the first to zone absorbs thermal energy from the fluid.

### BRIEF DESCRIPTION OF THE DRAWINGS

FIG. 1 is a schematic drawing of a first embodiment of a thermal energy storage apparatus connected to a source of thermal energy and a thermal energy consuming device;

FIG. 2 is a schematic drawing of a thermal energy storage apparatus during the charging phase of the charge/discharge cycle;

FIG. 3 is a schematic drawing of a thermal energy storage apparatus during the discharging phase of the charge/discharge cycle;

FIG. 4 is a perspective view of an embodiment of a packing element that functions as thermal energy storage media; and

FIG. 5 is a process flow chart.

### DETAILED DESCRIPTION

As used herein, the terms “heat” and “thermal energy” may be used interchangeably.

The need to extract, store and subsequently release large quantities of heat is a common requirement for many industrial processes. Technology to absorb and release heat has been disclosed in numerous patents and other literature with reference to solar powered electrical generating stations and many chemical processes that incorporate an exothermic reaction. Some of the teachings are directed to the media used to transfer the heat from a first fluid to a second fluid. Other teachings are directed to the process that generates the heat or the process that uses the heat after it has been stored and then released. This invention is directed to the thermal energy storage apparatus functionally disposed between the process that generates thermal energy and the process that utilizes the thermal energy.

One embodiment of a conventional thermal energy storage apparatus used in an industrial application is a large tank substantially filled with a solid material such as gravel or ceramic heat transfer media. A hot fluid, such as a hot exhaust gas or hot oil, passes through the media and the heat is absorbed by the media. Depending upon the application, the tank may be a large vessel that measures several meters in diameter and ratio of the vessel's height to diameter is at least 1:3. The size of the vessel is determined by the thermal storage capacity, typically measured as kilojoules, needed to operate the process. The thermal capacity of the vessel is directly influenced by the thermal capacity of the individual pieces of media and the number of media disposed in the vessel. The use of a single vessel may be suitable when the supply of heat to be absorbed is highly predictable and reasonably constant over time. However, when the rate at which heat is supplied and/or the total quantity of heat supplied varies significantly, the use of a large tank as a heat reservoir may be problematic for the following reasons. First, the thermal efficiency of a large volume of heat absorbing media may be unacceptably low if either the quantity of fluid or the temperature of the fluid flowing over the media is too low. This problem, which is characteristic of large heat storage reservoirs, cannot be readily solved by simply changing only the rate at which the heated fluid flows into and out of the heat storage reservoir. Similarly, the same problem cannot be solved by changing only the temperature of the heated fluid flowing into the heat storage reservoir. Both the quantity and temperature of the fluid must be sufficiently high to enable thermally efficient heat exchange to occur. Consequently, if the quantity or temperature of fluid flowing into the reservoir varies significantly, then a large reservoir may not be able to absorb and release heat efficiently. Second, the pressure drop within a large heat reservoir-may negatively impact the cost of operating a thermal storage reservoir that experiences significant fluctuations in the rate of fluid flowing into the reservoir.

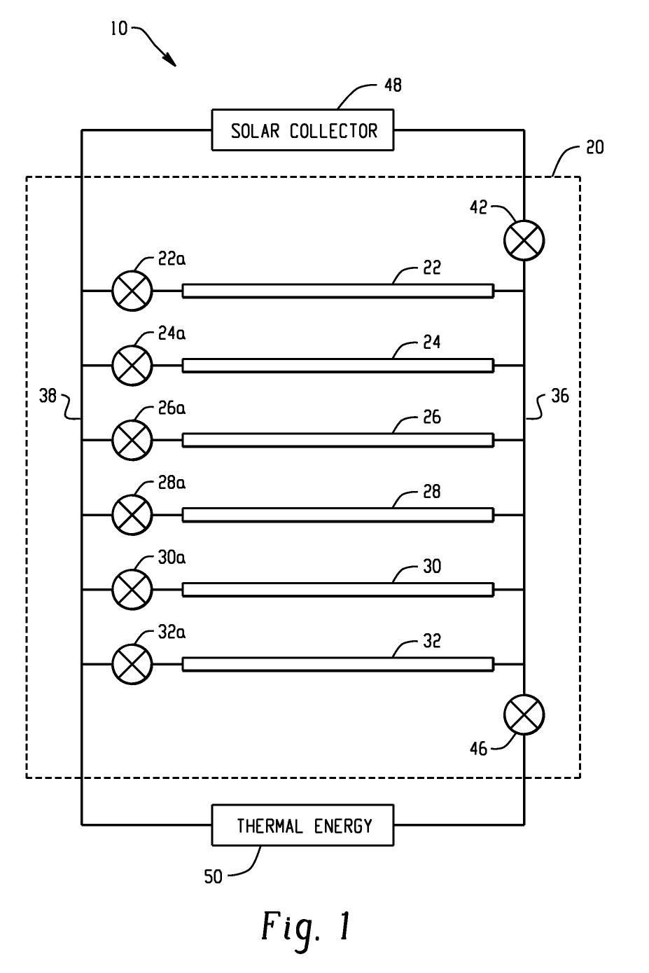

The problems associated with using a large thermal energy storage reservoir to store and release heat from a highly variable source of heat have been substantially resolved by using the thermal energy storage apparatus conceived by the inventors and described below. An apparatus of this invention provides a modular design which can be readily adjusted to accommodate changes in the rate of flow and temperature of the fluid in the reservoir. Referring now to the drawings and more particularly to FIG. 1, there is shown a schematic view of a thermal energy storage apparatus 10 of this invention which deviates from a large thermal energy reservoir by using a plurality of energy storage zones 22, 24, 26, 28, 30 and 32. Each zone contains thermal storage media. The total quantity of thermal storage media in the apparatus is equally distributed among the plurality of zones. Each zone is connected to fluid distribution system. A fluid (not shown) circulates through the zones and the distribution system. Several flow control valves, such as valves 22a, 24a, 26a, 28a, 30a, 32a, 42 and 46 are included in the means for separately and independently controlling the flow of fluid through each zone.

As described above, the total quantity of thermal storage media in the thermal storage apparatus is equally distributed among the energy storage zones. The reason for standardizing the quantity of thermal storage media in each zone is to create energy storage zones that have essentially the same thermal storage capacity and thermal performance characteristics. In addition to having the same quantity of thermal storage media in each zone, the internal volume of each zone should also be the same. A thermal storage apparatus that has a plurality of thermal storage zones with the same thermal storage capacity in each zone is a modular system that can be readily controlled to respond to rapid and unpredictable changes to the supply of thermal energy to the storage apparatus and the demand for thermal energy from the storage apparatus. The ability to quickly accept or supply thermal energy is particularly important for certain processes where the source of thermal energy is inherently variable and can change rapidly within a short period of time.

To create energy storage zones that have essentially the same thermal storage capacity, the quantity of thermal storage media in each zone and the to volume and shape of the zones may be standardized so that each zone is a virtual duplicate of the other zones. If the zones in a thermal energy storage apparatus are pipes filled with thermal storage media, then the diameter and length of the pipes should be the same for all of the zones. As used herein, a plurality of energy storage zones are considered to have the same thermal storage capacity if the thermal storage capacity of each zone is within five percent of the zones' average thermal storage capacity. Similarly, the internal volume of a plurality of energy storage zones are considered to have the same internal volume if the internal volume of each zone is within five percent of the zones' average internal volume.

In addition to standardizing the thermal capacity and internal volume of the zones, the rate of flow into and out of the energy storage zones may also be controlled to insure that the maximum rate of flow of liquid through each zone is essentially the same. The rate of fluid flow into a zone may be controlled by one or more flow control valves located at an end of an energy storage zone. The maximum rates of fluid flow into a plurality of zones are considered to be equal to the maximum rate of flow into each zone is within five percent of the zones' average maximum rate of flow.

With regard to the thermal storage media, the media within a single zone may be homogenous or there may be sub-zones within a single zone provided all of the thermal energy storage zones have the same sub-zones. For example, if first energy storage zone 22 includes: a first sub-zone that occupies 50 percent of the first zone's internal volume and is filled with a first media: and a second sub-zone that occupies the remaining 50 percent of the first zone's internal volume and is filled with a second media which is different from the first media, then second energy storage zone 24 should also include a first sub-zone filled with the same first media and a second sub-zone filled with the same second media. Each of the sub-zones in the second media should also occupy 50 percent of the second zone's internal volume.

A thermal energy storage apparatus of this invention functions by receiving a heated fluid from a means for heating a fluid, then absorbing and retaining thermal energy, and then releasing the thermal energy to a means for utilizing the thermal energy. As used herein, means for heating a fluid may be selected from the group consisting of a thermal solar collector, a cooling tower and an exothermic process. As used herein, means for utilizing thermal energy may be selected from the group consisting of a solar hot water heater and a steam driven turbine. With reference to FIG. 1, the fluid distribution system includes a first fluid header 36, a second fluid header 38 and flow control valves 42 and 46. The first fluid header may be referred to herein as a first fluid conveyance member. The second fluid header may be referred to herein as a second fluid conveyance member. In operation, when valve 42 is open and valve 46 is closed, hot fluid from the source of thermal energy must be conveyed through one or more of the energy storage zones where heat is extracted and the fluid is then returned to the source of thermal energy. In contrast, if valve 42 is closed and valve 46 is open, then fluid can flow from the energy storage zones to the process that uses the thermal energy and then back to the energy storage zones for reheating. More specific examples of how the system comprising the thermal energy storage apparatus can be operated will be provided below.

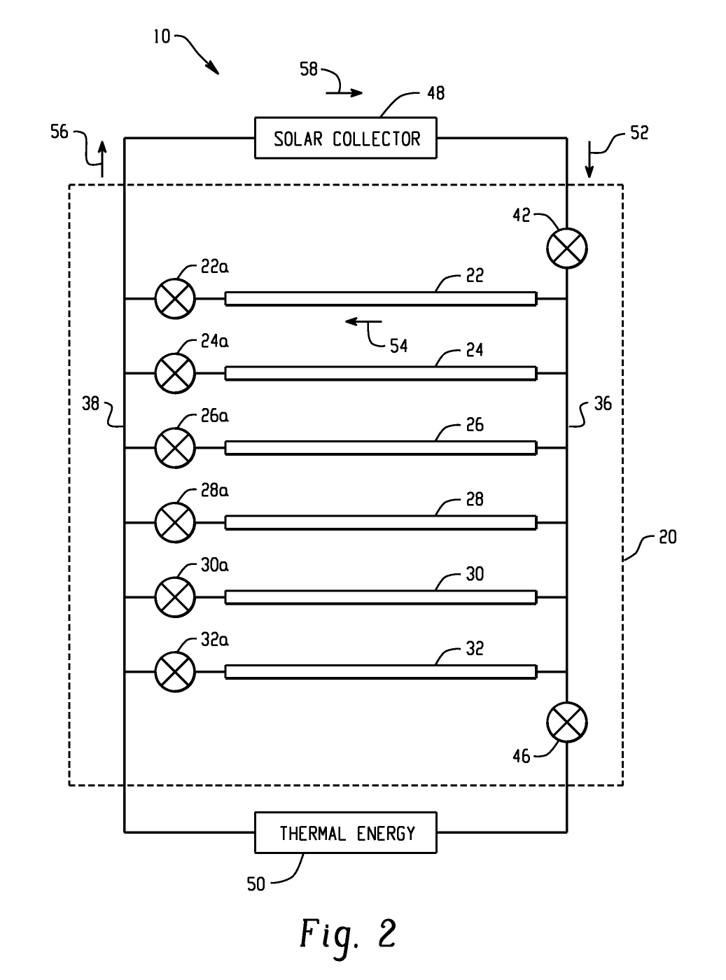

With reference to FIG. 2, a specific example of how a system comprising a thermal energy storage apparatus of this invention can be operated to store thermal energy in the thermal storage apparatus will now be provided. This sequence may also be referred to herein as the thermal charging phase. The system is initially configured by opening valves 42 and 22a. All other valves in the system are closed. As indicated by arrows 52, 54, 56 and 58, hot fluid flows from a concentrated solar collector, represented by means 48, through a fluid conveyance member to first energy storage zone 22 and then through a second fluid conveyance member to the solar collector. In this embodiment, the first energy storage zone may be a metal pipe having a constant internal diameter. Thermal energy in the heated fluid flowing from the solar collector is absorbed by ceramic heat exchange media in the pipe. After the media has absorbed heat to equal to 10 percent of the first zone's thermal capacity, valve 24a is opened thereby allowing fluid to flow through second energy storage zone 24. A first portion of the fluid from the solar collector flows through first zone 22 and a second portion of the fluid from the solar collector simultaneously flows through second zone 24 while no fluid flows through remaining zones 26, 28, 30 or 32. After the first zone has absorbed thermal energy equal to 90 percent of the first zone's thermal capacity, valve 22a is closed thereby forcing all of the fluid flow through the second zone. When the second zone has absorbed thermal energy equal to 10 percent of the second zone's thermal capacity, valve 26a is opened so that fluid simultaneously flows through the second zone and the third zone. After the second zone absorbs thermal energy equal to 90 percent of the second zone's thermal capacity, valve 24a is closed thereby forcing all of the fluid to flow through third zone 26. This process may be repeated until all of the zones have absorbed at least 90 percent of their thermal capacity. Alternately, the process may be repeated until the thermal energy storage apparatus is required to supply heat to, for example, a steam driven turbine represented by means for utilizing thermal energy 50.

In another embodiment of the charging cycle, the system is configured by opening valves 22a, 24a, 26a, 28a, 30a, 32a and 42. All other valves in the system are closed. This configuration allows heated fluid to flow simultaneously through each of the zones thereby charging all of the zones at the same time.

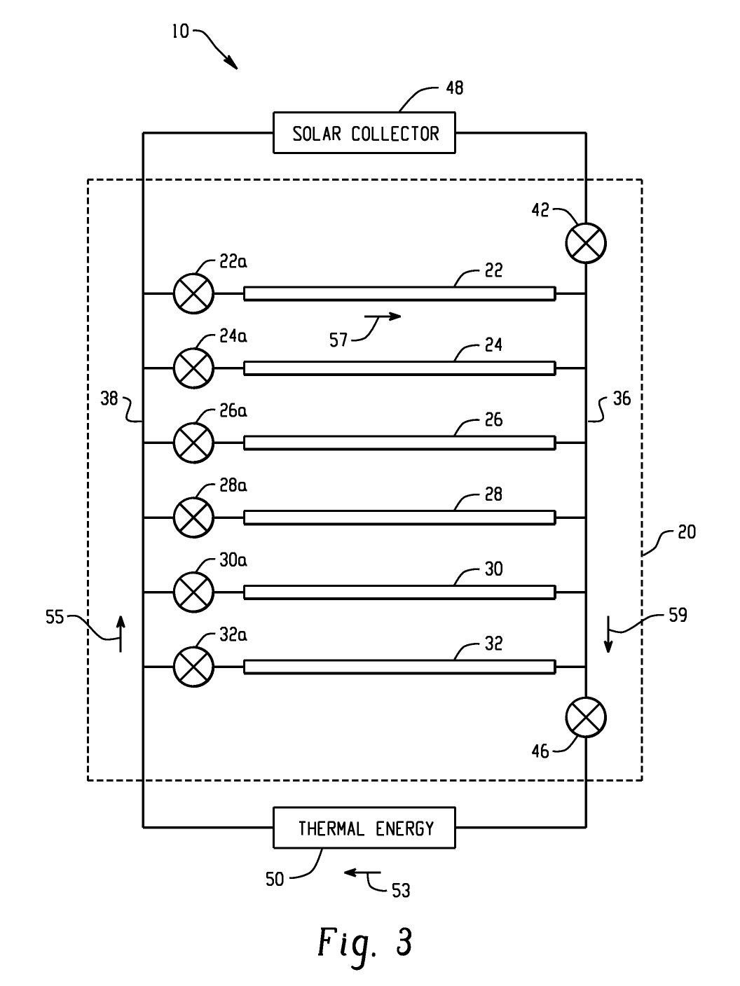

FIG. 3 represents the operation of a system that incorporates a thermal energy storage apparatus of this invention when the following three conditions exist. This sequence may also be referred to herein as the thermal discharging phase. First, zones 22, 24 and 26 have each absorbed at least 90 percent of their thermal capacity. Second, zones 28, 30, and 32 have not absorbed any thermal energy. Third, the energy storage zones need to supply heat to the turbine. Thermal energy from the energy storage zones may be supplied to the turbine by closing valve 42 and opening valves 22a and 46. As indicated by arrows 53, 55, 57 and 59, fluid is then made to circulate from the turbine through second fluid to conveyance member 38, first energy storage zone 22, then first fluid conveyance member 36 and back to the turbine. This process is completed until the quantity of thermal energy remaining in the first zone approaches 10 percent of the first zone's thermal capacity at which time valve 24a is opened so that fluid simultaneously flows through first zone 22 and second zone 24. When the quantity of thermal energy remaining in the first zone drops below ten percent of the first zone's thermal capacity, then valve 22a is closed. If needed, the process continues in a similar manner to sequentially transfer thermal energy from zone 26 to a turbine represented by means for utilizing thermal energy 50. If the turbine does not require heat from the thermal energy storage apparatus, then valve 46 is closed, valve 42 and selected zone flow control valves are opened thereby allowing hot fluid from the solar collector to once again provide thermal energy to one or more of the thermal energy storage zones. If desired, valves 42, 46 and may be opened and flow control valves 22a through 32a may be closed so that hot fluid is transferred solely between the means for heating the fluid and means for utilizing the thermal energy.

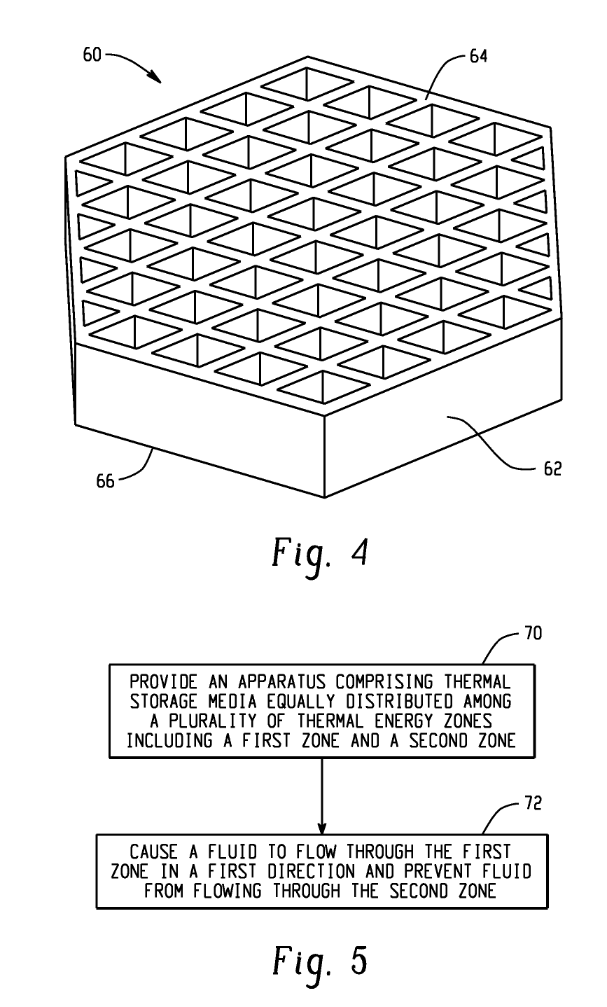

Referring now to FIG. 4, there is shown a perspective view of a first embodiment 60 of a ceramic media, also referred to herein as heat transfer media, which is useful in a thermal energy storage apparatus of this invention. This particular embodiment includes peripheral wall 62, first end face 64 and second end face 66. The packing element may be manufactured as described in U.S. Pat. No. 6,699,562 which generally discloses the use of any suitable ceramic materials such as natural or synthetic clays, zeolites, cordiertes, aluminas, zirconia, silica or mixtures of these. The formulation can be mixed with bonding agents, extrusion aids, pore formers, lubricants and the like.

FIG. 5 discloses a process flow chart. Step 70 represents providing a thermal energy storage apparatus comprising thermal storage media equally distributed among a plurality of energy storage zones including a first zone and a second zone. Each zone is connected to a fluid distribution system. A fluid circulates through the zones and the distribution system. Means for separately to and independently controlling the flow of fluid through each zone is provided. Step 72 represents causing the fluid to flow through the first zone in a first direction while preventing fluid from flowing through the second zone.

The above description is considered that of particular embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the Doctrine of Equivalents.

What is claimed is:

1. A thermal energy storage apparatus, comprising: thermal storage media equally distributed among a plurality of energy storage zones, each zone connected to a fluid distribution system; a fluid circulating through said zones and said distribution system; and means for separately and independently controlling the flow of fluid through each zone.

2. The apparatus of claim 1 wherein each zone has a thermal storage capacity and the thermal storage capacity of each zone is within five percent of the zones' average thermal storage capacity.

3. The apparatus of claim 1 wherein the internal volume of each zone is within five percent of the zones' average internal volume.

4. The apparatus of claim 1 wherein the internal volume of each zone has a constant diameter along the length of the zone and the diameter of each zone is within five percent of the zone's average diameter.

5. The apparatus of claim 1, wherein said fluid distribution system comprises a flow control value per zone which regulates the flow of fluid into said zone and the maximum rate of flow into each zone is within five percent of the average maximum rate of flow into all of the zones.

6. The apparatus of claim 1, wherein said fluid distribution system comprises a first fluid conveyance member and a second fluid conveyance member, each zone connected to both fluid conveyance members.

7. The apparatus of claim 6 wherein said zones are connected in parallel between the fluid conveyance members.

8. The apparatus of claim 1 wherein each thermal storage zone comprises at least two sub-zones.

9. The apparatus of claim 8 wherein each thermal storage zone comprises the same number of sub-zones.

10. The apparatus of claim 1 further comprises a means for heating said fluid, said means for heating said fluid connected to said thermal energy storage apparatus.

11. The apparatus of claim 10 wherein said means for heating is selected from the group consisting of a solar collector, a cooling tower and an exothermic process.

12. The apparatus of claim 1 further comprises a means for utilizing thermal energy connected to said thermal energy storage apparatus.

13. The apparatus of claim 12 wherein said means for utilizing thermal energy is selected from the group consisting of a steam driven turbine and a solar thermal hot water heater.

14. A process for extracting thermal energy from a fluid comprising the steps of:
(a) providing a thermal energy storage apparatus comprising thermal storage media equally distributed among a plurality of energy storage zones including a first zone and a second zone, each zone connected to a fluid distribution system; a fluid circulating through said zones and said distribution system; and means for separately and independently controlling the flow of fluid through each zone; and
(b) causing the fluid to flow through the first zone in a first direction and preventing fluid from flowing through the second zone, said media in said first zone absorbing thermal energy from the fluid.

15. The process of claim 14 wherein after the media in the first zone has absorbed at least ten percent of the media's thermal capacity, the process further comprises the step of causing the fluid to flow through the second zone.

16. The process of claim 15 wherein said fluid simultaneously flows through said first zone and said second zone.

17. The process of claim 16 wherein, after media in the first zone has absorbed at least 90 percent of the first zone's thermal capacity, fluid flow through said first zone is terminated while fluid flow through said second zone continues.

18. The process of claim 14 further comprising the step of causing the fluid to flow through at least the first zone in a second direction which is opposite to the first direction, said fluid absorbing thermal energy from said media in the first zone; and then directing the fluid to a means for utilizing the thermal energy.
